(19) United States
(12) Patent Application Publication
(10) Pub. No.: US 2002/0080627 A1
(43) Pub. Date: Jun. 27, 2002

(54) Isolated power controller

(76) Inventors: David F. Baretich, Lake Oswego, OR (US); Gregory P. Wiegand, Poulsbo, WA (US)

Correspondence Address: PATRICK M. DWYER PC, 1818 WESTLAKE AVENUE N, SUITE 114, SEATTLE, WA, 98109, US

(21) Appl. No.: 10/006,062

(22) Filed: Dec. 5, 2001

Related U.S. Application Data
(63) Continuation-in-part of application No. 09/802,809, filed on Mar. 8, 2001, now Pat. No. 6,366,062.
Application No. 09/802,809 is a division of application No. 09/241,831, filed on Feb. 1, 1999, now Pat. No. 6,229,288.
Application No. 09/241,831 is a continuation of application No. 08/860,878, filed on Dec. 8, 1997, now abandoned.
Application No. 08/860,878 is a continuation of application No. PCT/US96/00286, filed on Jan. 11, 1996.
Application No. PCT/US96/00286 is a continuation of application No. 08/371,512, filed on Jan. 11, 1995, now Pat. No. 5,747,972.
(60) Provisional application No. 60/255,957, filed on Dec. 15, 2000.

(51) Int. Cl. H02M 3/335

(52) U.S. Cl. 363/25

(57) ABSTRACT

An isolated power controller for regulating 0 to full voltage, wherein the output is fully regulated, the power is bi-directional, and the output of the IPC is fed into an LC averaging filter.

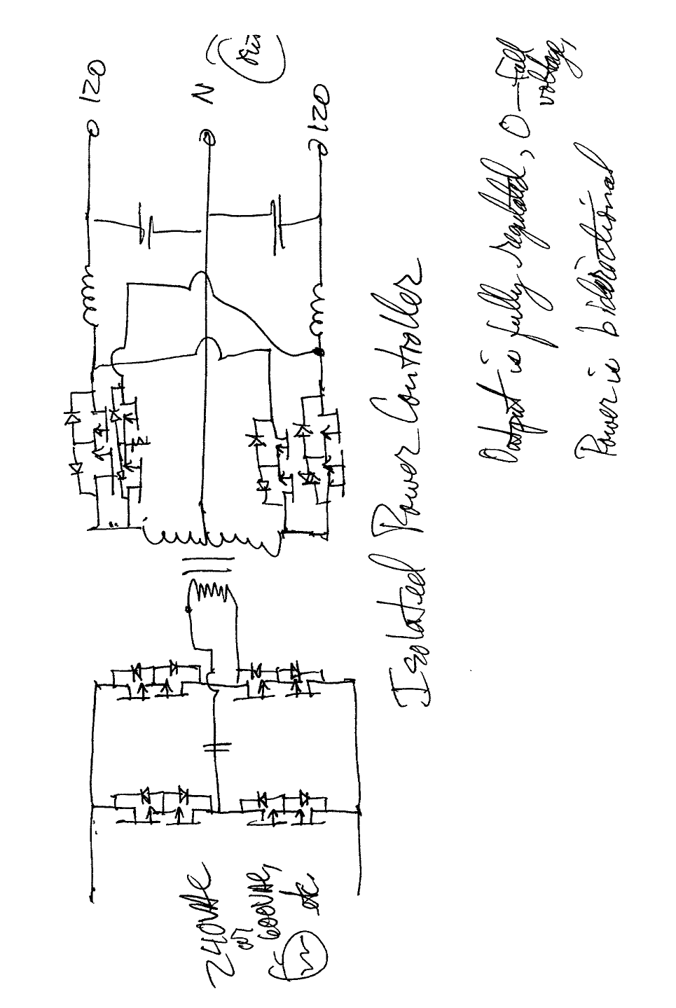

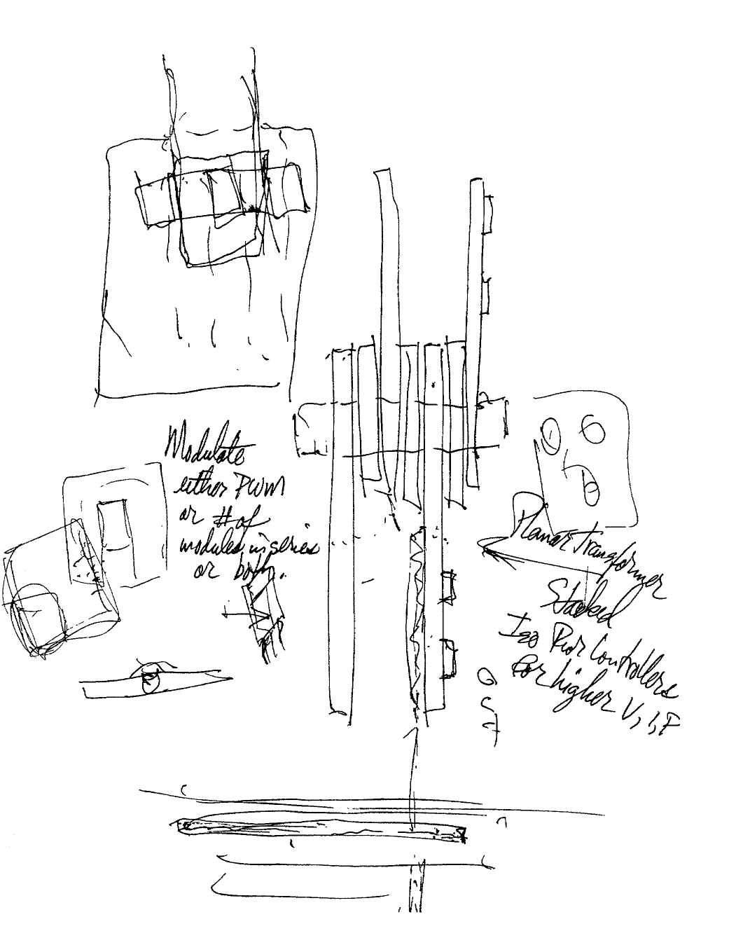

This application is a continuation-in-part of U.S. patent application Ser. No. 09/802,809 filed Mar. 8, 2001, which is a divisional of U.S. patent application Ser. No. 09/241,831 filed Feb. 1, 1999, now issued May 8, 2001 as U.S. Pat. No. 6,229,288, which is a continuation of U.S. patent application Ser. No. 08/860,878 filed Dec. 8, 1997, now abandoned, which is a continuation of PCT application No. PCT/US96/00286 filed Jan. 11, 1996, which was a continuation of U.S. patent application Ser. No. 08/371,512 filed Jan. 11, 1995, now issued May 5, 1998 as U.S. Pat. No. 5,747,972. This application also claims priority to U.S. Provisional Application No. 60/255,957 filed Dec. 15, 2000.

### TECHNICAL FIELD

This document concerns an isolated power controller. It accepts 600VAC input at nominally 60 Hz. and provides an isolated 240VCT output (120V-0V-120V) per normal residential voltage requirements. Regulation is provided over a +/−10% voltage range.

### BACKGROUND

The concept of an electronic transformer has been around for some time. For a variety of reasons, however, there have been few attempts at implementation. Two recent efforts have been made and presented as IEEE papers. The first apparently involved 15 KHz. operation and had a low measured efficiency of 80%. See K. Harada, F. Anan, K. Yamasaki, M. Jinno, Y. Kawata, T. Nakashima, K. Murata, and H. Sakamoto, “Intelligent Transformer,” in Conf. Rec. IEEE PESC, 1996, pp. 1337-1341. The second operates at a relatively low switching frequency of 960 Hz and was successfully tested at the 10 KW level with an overall efficiency of approximately 94%. See M. Kang, P. Enjeti, I. Pitel, “Analysis and Design of Electronic Transformers for Electric Power Distribution System,” IEEE Trans. Power Electron. vol. 14, pp. 1133-1141. However, this second design does not regulate output voltage, but merely acts like a passive transformer.

The Kang, Enjeti, Pitel Electronic Transformer

This device was based upon the idea of simply reducing transformer size by increasing frequency. A full bridge of bidirectional switches chops the input voltage into a 960 Hz square wave of fixed duty cycle. The voltage envelope of this square wave follows the instantaneous input voltage of the AC line and the resulting signal is fed into a silicon steel core transformer which has been optimized for 960 Hz. operation.

A similar output bridge effectively “unfolds” the signal and reconstitutes the original waveform. There is some dead time involved, which is filled in with an output filter capacitor. Since the output is peak detected and not modulated, output regulation is not possible, although it can be turned off electronically during overload conditions.

The chief advantage of this circuit is that it reduces the transformer to a third of its original size. The relatively low operating frequency allows the use of a silicon steel core transformer and minimizes switching losses in the IGBT power switches. The stated efficiency of 96% appears to not be correct. Further calculations place it at around 94%, which is still good.

The primary disadvantage of this approach is that regulation is not possible.

### DISCLOSURE

A third circuit which offers good efficiency combined with smaller size and regulated outputs is proposed. It is based on the MicroPlanetary Converter, and technology disclosed in U.S. Pat. No. 5,747,972 and U.S. patent application Ser. No. 09/241,831 soon to issue as a U.S. Patent, so that it is extended for isolated operation. The teachings of these two patent documents are herewith incorporated by reference as if fully set forth.

The Kang, Enjeti, Pitel approach discussed above is combined with a standard MicroPlanet Whole House Voltage Regulator and our patented technology referred to above to produce the MicroPlanet Isolated Power Controller (IPC). The MicroPlanet IPC is similar in general topology but has a number of significant differences.

Like the electronic transformer, the IPC employs a full bridge primary and secondary of bidirectional switches. However, they are made up of high speed IGBTs rather than the standard speed series and will operate between 10 KHz and 20 KHz.

Additionally, the output of the IPC is fed into an LC averaging filter rather than a simple capacitor. This allows for output voltage regulation as duty cycle is modulated at high frequency. EMI is also reduced by the more sophisticated output filter.

The IPC also contains a pulse width modulator and loop to accurately regulate the output of the controller without additional power circuitry. Moreover, it employs the patented MPC control system which has several advantages over existing control methods.

Predicted efficiency is above 90% over a wide load range and approaching the 94% full load efficiency of the previously discussed electronic transformer. At mid and lower power ranges, I would expect peak efficiency at 95% or better.

This compares reasonably with conventional 60 Hz transformers as there is considerable core loss (around 60W) that never goes away. At the 1KW level, that translates into a best efficiency of 94%.

Operating the output at a nominal 114 VAC would further reduce power consumption by the residence.

The resulting converter is easily scaled upward by either increasing the size of the converter or increasing the number of small converters. While many converters simply get larger in size, we optionally anticipate using multiple converters, surface mount power components, and planar circuit board transformers. There are more parts but the assembly is highly automated.

We claim:

1. An isolated power controller for regulating 0 to full voltage, wherein the output is fully regulated, the power is bidirectional, and the output of the IPC is fed into an LC averaging filter.
